(19) United States
(12) Patent Application Publication
(10) Pub. No.: US 2014/0156952 A1
(43) Pub. Date: Jun. 5, 2014

(54) INFORMATION PROCESSING APPARATUS, INFORMATION PROCESSING METHOD, AND COMPUTER READABLE MEDIUM

(71) Applicant: KABUSHIKI KAISHA TOSHIBA, Tokyo (JP)

(72) Inventor: Kentaro Takeda, Tokyo (JP)

(73) Assignee: KABUSHIKI KAISHA TOSHIBA, Tokyo (JP)

(21) Appl. No.: 13/970,323

(22) Filed: Aug. 19, 2013

(30) Foreign Application Priority Data
Nov. 30, 2012 (JP) 2012-263492

(51) Int. Cl. G06F 12/00

(52) U.S. Cl. CPC G06F 12/00
USPC 711/147

(57) ABSTRACT

According to one embodiment, an information processing apparatus with mode switching function, includes a first management module which is capable of accessing a predetermined area of a memory, and a second management module which is capable of accessing the predetermined area and another area of the memory. The first management module is incapable of accessing the other area of the memory. The second management module is configured to exchange information in the predetermined area for information in the other area, in accordance with mode switching.

### CROSS-REFERENCE TO RELATED APPLICATIONS

This application is based upon and claims the benefit of priority from Japanese Patent Application No. 2012-263492, filed Nov. 30, 2012; the entire contents of which are incorporated herein by reference.

### FIELD

Embodiments described herein relate generally to an information processing apparatus with mode switching function, an information processing method, and a computer readable medium.

### BACKGROUND

In recent years, companies have realized that it is advantageous to allow staff to bring their own IT (information technology) devices to the office and use them to do their jobs (BYOD: Bring Your Own Device). As the IT devices, it is possible to use equipment such as tablet computers and smartphones. To realize BYOD, it is necessary to establish security measures during the IT devices are used for business.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram illustrating an example of hardware configuration of an information processing apparatus according to an embodiment.

FIG. 2 is a diagram illustrating an example of a functional configuration of the information processing apparatus according to the embodiment.

FIG. 3A is a diagram illustrating an example of rules stored in a determination module of the information processing apparatus according to the embodiment.

FIG. 3B is a diagram illustrating another example of the rules stored in the determination module of the information processing apparatus according to the embodiment.

FIG. 4 is a diagram illustrating an example of area arrangement of a storage device 18 according to the embodiment.

FIG. 5 is a diagram illustrating an example of flow of use switching processing of the information processing apparatus according to the embodiment.

FIG. 6 is a sequence diagram illustrating an example of switching the information processing apparatus according to the embodiment from business use to private use.

FIG. 7 is a sequence diagram illustrating an example of switching the information processing apparatus according to the embodiment from private use to business use.

### DETAILED DESCRIPTION

Embodiments will be described herein with reference to drawings.

Various embodiments will be described hereinafter with reference to the accompanying drawings.

In general, according to one embodiment, an information processing apparatus with mode switching function, includes a first management module which is capable of accessing a predetermined area of a memory, and a second management module which is capable of accessing the predetermined area and another area of the memory. The first management module is incapable of accessing the other area of the memory. The second management module is configured to exchange information in the predetermined area for information in the other area, in accordance with mode switching.

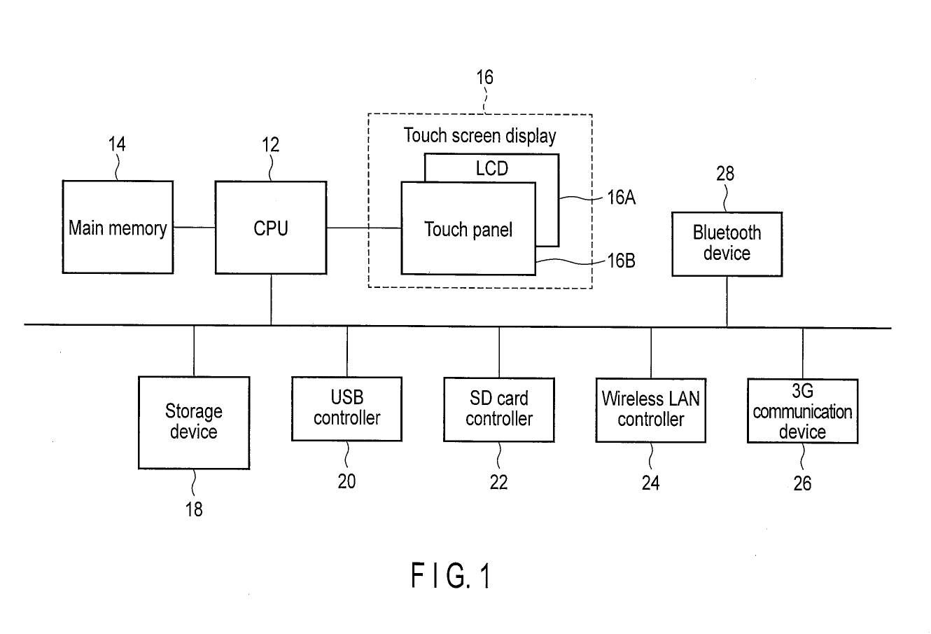

FIG. 1 illustrates hardware configuration of an information processing apparatus according to an embodiment. The information processing apparatus is configured to execute various software programs. For example, the information processing apparatus is realized by a tablet computer, a notebook personal computer, a smartphone, a PDA, and another information terminal. The following explanation shows the case where the information processing apparatus is a tablet computer. Although a keyboard is provided on the screen as a software keyboard in the tablet computer, an external hardware keyboard may be attached to the tablet computer.

The information processing apparatus can be used for business purpose or business mode in the office, and for private purpose or private mode outside the office. When the apparatus is used in different modes as described above, it is desirable that the apparatus can be used as different apparatuses for individual modes. For example, with respect to an application program, it is desirable that the user cannot access a business file, which was prepared in the office, when the user uses the apparatuses for private mode outside the office. On the contrary, the user cannot access a private file, which was prepared at home, when the user uses the apparatus for business mode in the office. The user may access all the files of some programs in the same manner, regardless of the mode. In addition, there are cases where it is desirable to switch various settings in the application program according to the mode, as well as limiting access to the files. As described above, by limiting accesses to the files according to the mode, security can be maintained when the apparatus is used in a business mode, and it is possible to switch uses of an information processing apparatus. The uses of the information processing apparatus are not limited to two, that is, business use and private use, but may be three or more.

The information processing apparatus being a tablet computer includes a CPU 12, a main memory 14, a touch screen display 16, a storage device 18, a USB controller 20, an SD card controller 22, a wireless LAN controller 24, a 3G (3rd generation) communication device 26, and a Bluetooth (registered trademark) device 28.

The CPU 12 is a processor which controls the components in the information processing apparatus. The CPU 12 executes various software programs which are loaded from the storage device 18 that is a solid state drive or a hard disk drive into the main memory 14, such as an OS, application programs, or utility programs. The application programs include, for example, a document preparing application, and a spreadsheet application.

The touch screen display 16 is a display which can detect a touch position on the screen. The touch screen display 16 includes a flat panel display 16A such as a liquid crystal display device (LCD), and a touch panel 16B.

The USB controller 20 is configured to execute communication with a USB device (such as a flash drive) which is attached to a USB port that is provided in the information processing apparatus. The SD card controller 22 is configured to execute communication with a memory card (such as an SD card) which is inserted into a card slot that is provided in the information processing apparatus. The wireless LAN controller 24 is a wireless communication device configured to execute wireless communication that is compliant with Wi-Fi (registered trademark). The 3 G communication device 26 is a wireless communication device configured to execute 3G mobile communication. The Bluetooth device 28 is a wireless communication device configured to execute communication with an external Bluetooth device.

As described above, the information processing apparatus is configured to execute wireless communications which are compliant with some wireless communication standards. By using the wireless communication function, the information processing apparatus can communicate with an external communication device and an office network which include a wireless access point, or various servers on the Internet.

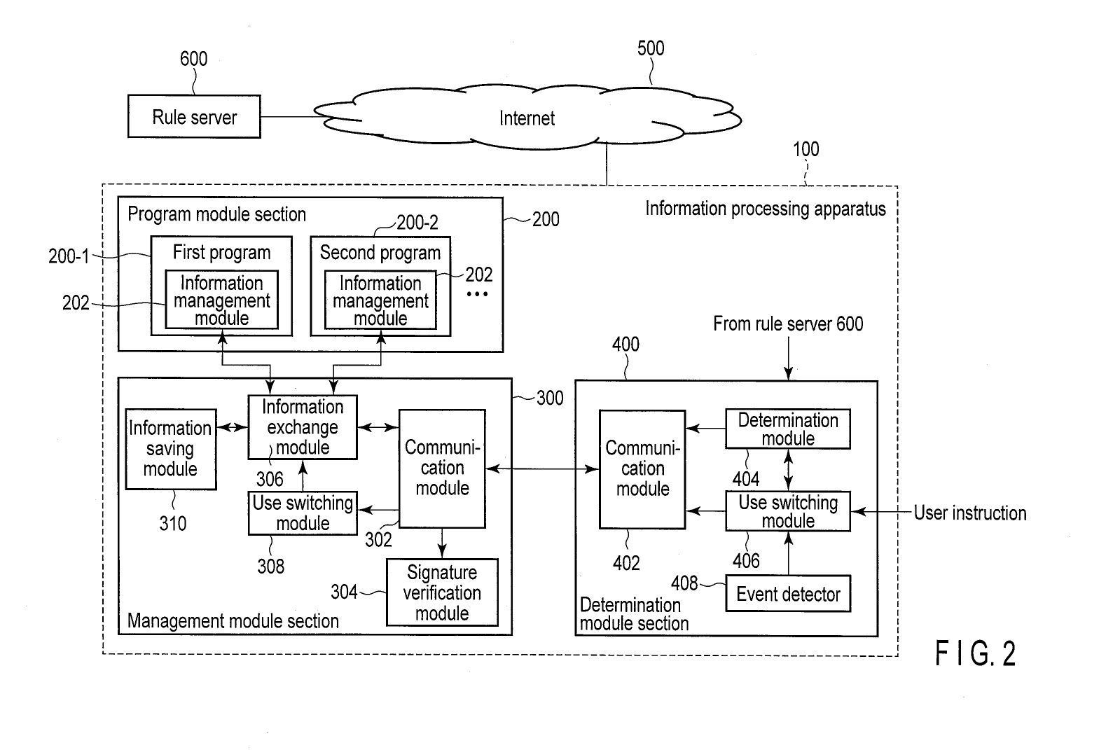

FIG. 2 illustrates functional configuration of the information processing apparatus 100 according to the embodiment. As described above, the information processing apparatus 100 has a function of taking different security measures according to the use, by switching accessible information items between, for example, an operation mode for private use at home and an operation mode for business use in the office. To realize the function, the information processing apparatus 100 includes a program module section 200, a management module section 300, and a determination module section 400. When these module sections are formed of hardware, they may be formed as one unitary piece in a chip, or formed as separate module sections on separate chips. Also in the case where the module sections are formed of software, they may be formed as one program, or as separate programs.

The program module section 200 is a platform for executing various software programs. The program module section 200 can be realized as a virtual machine such as a Java (registered trademark) virtual machine.

The information processing apparatus 100 can download various software programs through the Internet 500. The downloaded software programs are stored in the storage device 18. The software programs include not only application programs, but also utility programs.

The program module section 200 includes a number of programs, that is, a first program 200-1, a second program 200-2, . . . , and each program includes an information management module 202. The information management module 202 manages information (such as document files in a document preparation program) which is used by the program, and information relating to the setting state. Actually, these information items are stored in memory areas which are assigned to the respective programs in the storage device 18. Therefore, the information management module 202 can access the main memory 14, and access the memory area (hereinafter also referred to as a “program area”) assigned to the program in the storage device 18. The information management module 202 has a sandbox structure in which the information management module 202 cannot access any memory area which is assigned to another program in the storage device 18.

The management module section 300 includes a communication module 302, a signature verification module 304, an information exchange module 306, a use switching module 308, and an information saving module 310.

The communication module 302 communicates with the communication module 402 of the determination module section 400, and receives a switching instruction from the determination module section 400. When a switching instruction is received from the determination module section 400, the signature verification module 304 determines whether the determination module section 400 is reliable or not. Since there are cases where the management module section 300 and the determination module section 400 are formed as separate modules, the determination is performed to prevent dishonest use switching by a falsified determination module section.

The use switching module 308 switches internal mode, in accordance with a switching instruction which is transmitted from the determination module section 400 and inputted through the communication module 302, and thereby controls the information exchange module 306. As described above, however, since it differs according to the program whether to execute/skip exchanging information items, it is determined for each program whether to exchange information items or not. Since the determination module section 400 has the criteria for determination, actually, the use switching module 308 inquires of the determination module section 400 through the communication module 302, and performs control to operate/not to operate the information exchange module 306 in accordance with an inquiry result received from the determination module section 400.

The information exchange module 306 is connected with the information saving module 310 and the information management modules 202 of the respective programs, and exchanges the information managed by the program for the information managed by the management module section 300 when the use of the information processing apparatus is switched. The information saving module 310 has the same function as that of the information management module 202 of each program. The information saving module 310 can access the main memory 14 which serves as a buffer memory in information exchange, and access a memory area (hereinafter also referred to as a “saving area”) of the storage device 18 that is assigned to the management module section 300, and all the program areas of the storage device 18 assigned to the program. The information managed by the information saving module 310 has a sandbox structure which cannot be accessed from the information management modules 202 of the other programs, like the information managed by the information management module 202. The information saving module 310 has a special right, however, and can access (read and write) information items managed by the information management modules 202 of all the programs.

By exchanging the information items, the information which can be accessed by each program 200-1, 200-2, . . . , of the program module section 200 can be changed according to the use. It is unnecessary, however, to change access limitations for a program that requires low security, according to the use. Specifically, it is possible to access the same information of the program, regardless of the use. These limitations varies between companies which adopt BYOD, and it is defined as rules for each company for which program the access limitations are to be changed according to the use.

The determination module section 400 also includes a determination module 404, a use switching module 406, and an event detector 408, in addition to the communication module 402.

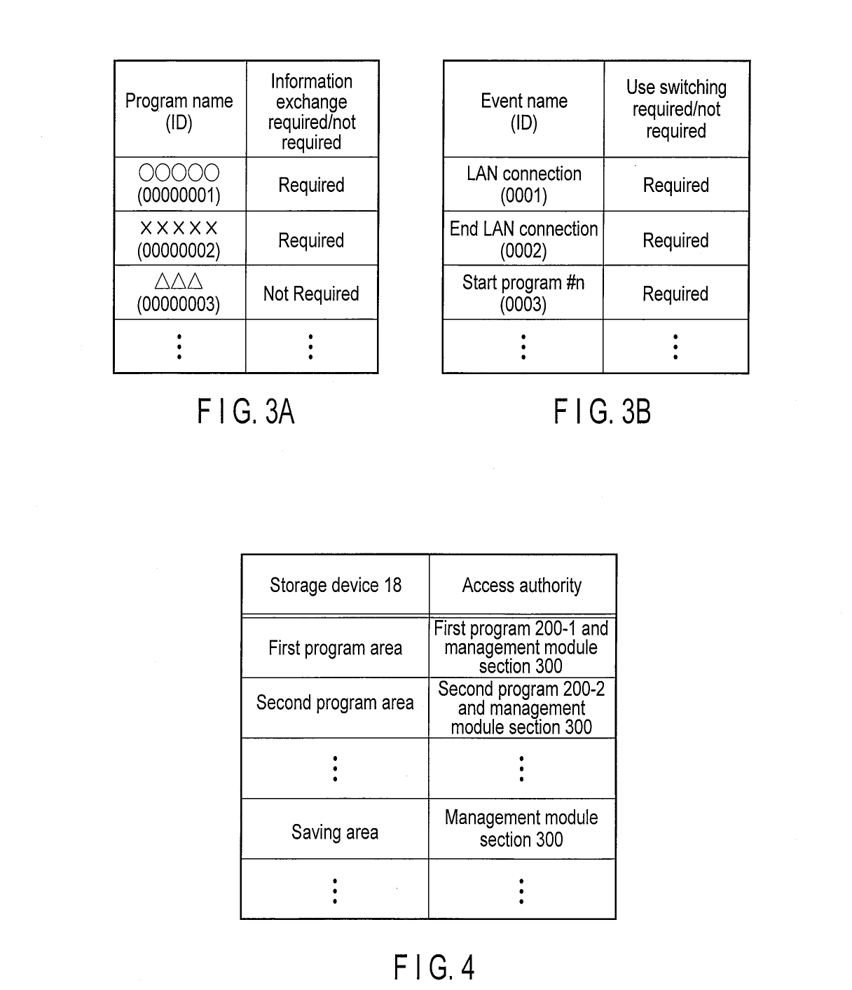

The information processing apparatus 100 can communicate with various servers on the Internet 500, such as a rule server 600, by using the wireless communication function. The rule server 600 stores rules (information which indicates for which program the access limitations are to be changed according to the use) as described above. The determination module section 400 downloads the rules from the rule server 600, and the determination module section 400 stores the rules. FIG. 3A illustrates an example of the rules.

The event detector 408 detects an event which requests connection to any of various external communication devices, and notifies the use switching module 406 of details of the detected event. The request to be connected to an external communication device includes, for example, a request to connect to a Wi-Fi access point, and a request to connect to a Bluetooth device. The event detector 408 can detect not only an event (network connection event) which requests connection to an external communication device, but also various events which request various processing other than connection to an external communication device. For example, the event detector 408 detects various events, such as an SD card connection request, a flash drive connection request, and an application program start request.

The use switching module 406 executes use switching processing based on the rules. The rules specifies not only programs for which information items are to be exchanged, but also events at which use switching is started, such as an event of connection/disconnection of the apparatus to/from the office LAN, as shown in FIG. 3B. The rules are different between companies, and the rules are updated as required. It is difficult to reflect change of the rules in all the information processing apparatuses used in the office, each time when the rules are updated. Therefore, adopted is a structure of downloading the rules from the rule server 600 to all the information processing apparatuses 100 that are used in the company, and the rules are updated on the rule server 600. By downloading the updated rules, it is possible to easily reflect change of the rules in all the information processing apparatuses 100 used in the company. The download is performed by sending a request from the information processing apparatus 100 to the rule server 600. For example, the information processing apparatus 100 may be configured to send a download request every several minutes, as long as the information processing apparatus 100 is connected to the Internet 500.

When the use switching module 406 receives a use switching instruction transmitted by the user from a start menu or the like, or an event detection result from the event detector 408, the use switching module 406 determines whether to start use switching or not, based on the rules stored in the determination module 404. When it is determined to start switching, the use switching module 406 transmits a use switching instruction to the management module section 300 through the communication module 402.

The determination module 404 also has a function of receiving an inquiry (as to whether the information of the program is to be exchanged or not) from the management module section 300 through the communication module 302, and transmits a determination result to the management module section 300 through the communication module 402 in return.

FIG. 4 is a diagram illustrating relation between a memory space of the storage device 18 and the access authority. The memory space includes a first program area, a second program area, . . . , which are assigned to the respective programs, and a saving area which is assigned to the management module section 300. The access authority of the first program area is given to the information management module 202 of the first program 202-1 and the information saving module 310 of the management module section 300. The access authority of the second program area is given to the information management module 202 of the second program 202-2 and the information saving module 310 of the management module section 300. The access authority of the saving area is given only to the information saving module 310 of the management module section 300.

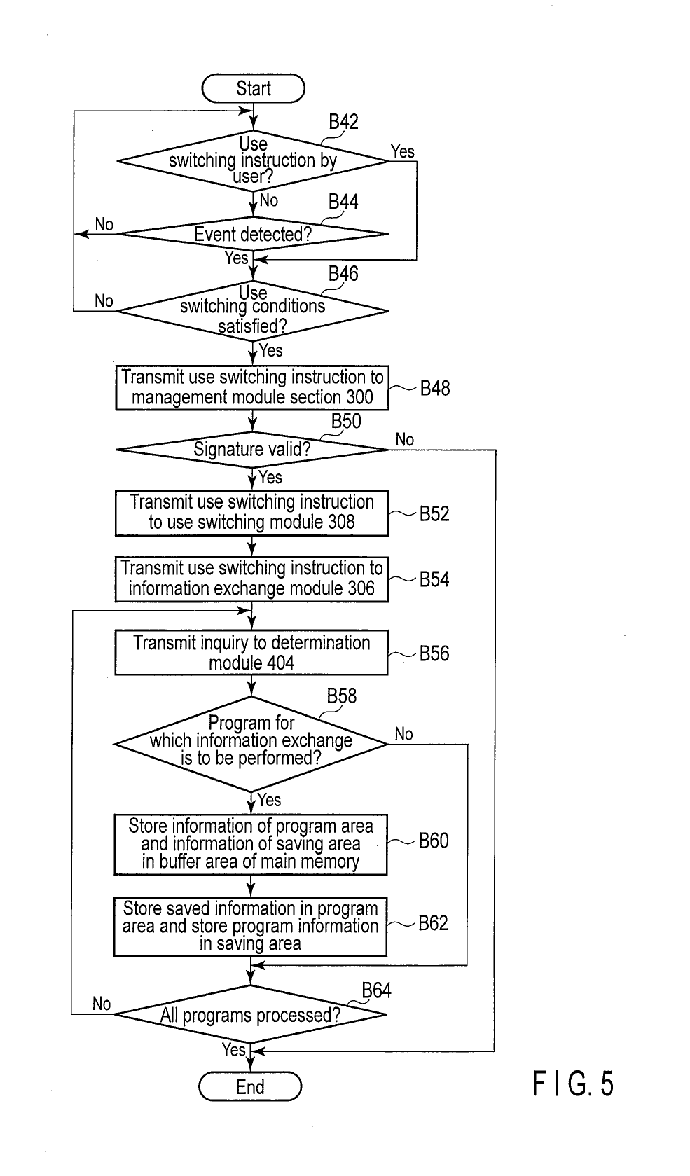

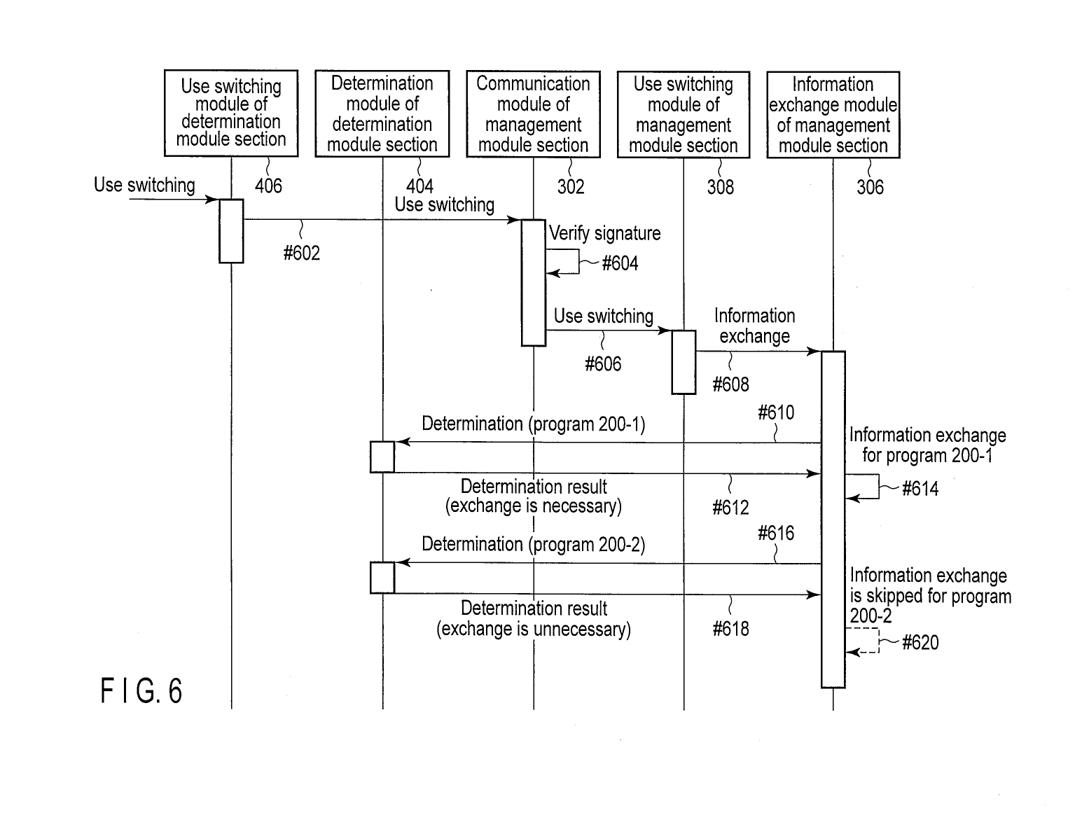

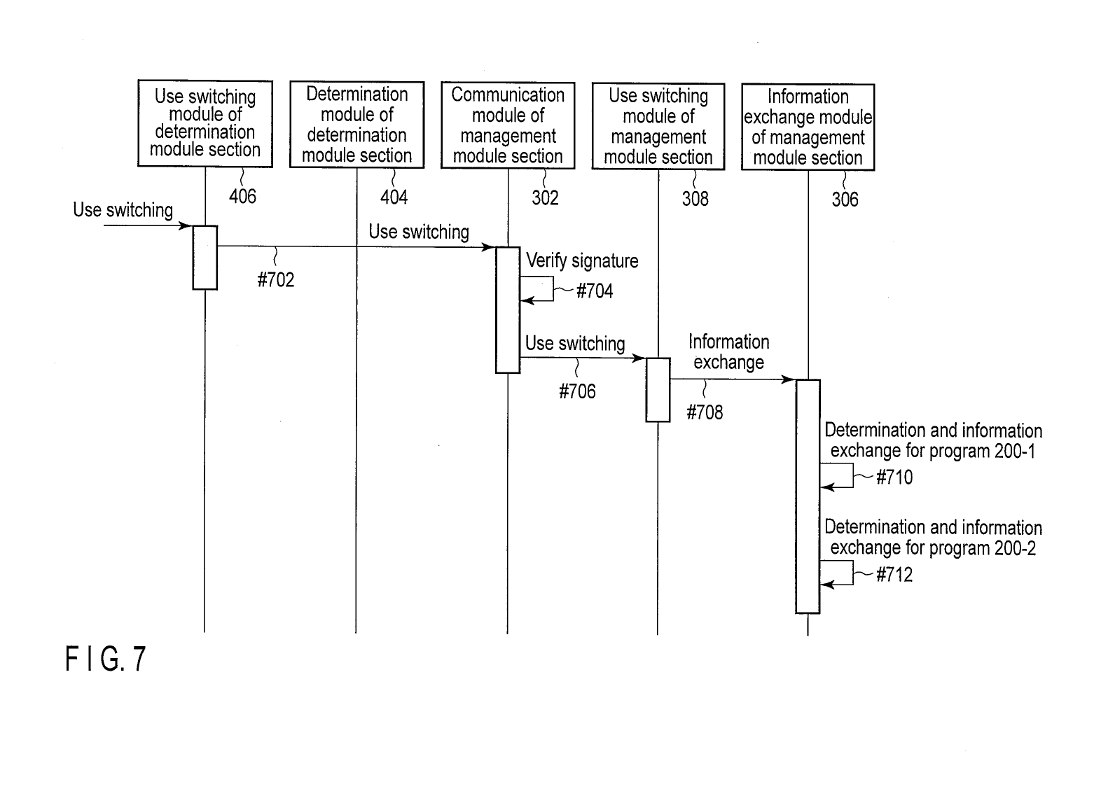

The flow of information exchange processing accompanying switching of the use of the information processing apparatus 100 will be explained with reference to FIG. 5. FIG. 6 is a sequence diagram in the case of switching the apparatus from business use to private use. FIG. 7 is a sequence diagram in the case of switching the apparatus from private use to business use.

In Block B42, the use switching module 406 of the determination module section 400 determines whether a use switching instruction transmitted by the user has been received or not. When a use switching instruction transmitted by the user is received, Block B44 is skipped, and the flow goes to Block B46. When no use switching instruction transmitted by the user is received, the use switching module 406 of the determination module section 400 determines at Block 44 whether the event detector 408 has detected an event. When no events are detected, the flow returns to Block B42. When an event is detected, the flow goes to Block B46. Specifically, when a use switching instruction transmitted by the user is received in Block B42 or an event is detected in Block B44, Block 46 is executed.

In Block B46, the use switching module 406 of the determination module section 400 determines whether use switching conditions are satisfied or not. Specifically, the use switching module 406 determines, based on the rules stored in the determination module 404, whether the use switching instruction by the user can be approved or not, or whether the detected event is a specific event for switching uses. The use switching instruction by the user can be generated by selecting a use in the start menu of the information processing apparatus 100 when, for example, the user comes to the office or leaves the office. There are the cases where, however, the user issues a use switching instruction by mistake or illegally, it is determined in Block B46 whether switching is allowable at present or not, in the case of receiving the user's instruction. For example, during business time for which the apparatus is connected to the office network, switching uses is not allowed. Thereby, it is possible to prevent erroneous or illegal switching of uses by the user.

On the other hand, the present embodiment has a structure in which a use switching instruction is automatically generated, when a specific event which is defined in the rules is detected, as well as the user's instruction. For example, when it is necessary to connect the information processing apparatus to the office network during business time, the embodiment may be configured to automatically switch the uses when the information processing apparatus detects a connection/disconnection event to/from the office network. Therefore, the use switching module 406 is notified of information of the event detected by the event detector 408, and the use switching module 406 determines whether the detected event is a use switching event or not, with reference to the rules (FIG. 3B) stored in the determination module 404. As described above, since a use switching instruction can automatically be generated, even when the user forgets to issue a use switching instruction, it is possible to securely switch the uses. Therefore, it is possible to prevent the user from accessing business files outside the office, and forgetting to take measures for security. In addition, since events for which a switching instruction is automatically generated are determined by the rules, an event for which a switching instruction is generated can be changed easily and securely.

When the use switching conditions are not satisfied in Block B46, the flow returns to Block B42. When the use switching conditions are satisfied in Block B46, the use switching module 406 of the determination module section 400 transmits, in Block 48, a use switching instruction to the communication module 302 of the management module section 300 (Step #602 of FIG. 6, Step #702 of FIG. 7). The use switching instruction includes a signature of the determination module.

In Block B50, the signature verification module 304 of the management module section 300 determines whether the signature included in the use switching instruction is valid or not, that is, whether the determination module section 400 is reliable or not (Step #604 of FIG. 6, Step #704 of FIG. 7). When the signature is invalid, the processing is ended. When the signature is valid, the flow goes to Block B52. This structure prevents illegal use switching by a falsified determination module section 400.

In Block B52, the communication module 302 of the management module section 300 transmits a use switching instruction to the use switching module 308 (Step #606 of FIG. 6, Step #706 of FIG. 7).

In Block B54, the use switching module 308 of the management module section 300 transmits a use switching instruction to the information exchange module 306 (Step #608 of FIG. 6, Step #708 of FIG. 7).

The use switching module 308 switches the internal modes in response to the switching instruction. Although the program module section 200 includes a number of programs, all the programs do not need information exchange when use switching is performed. Therefore, in Block B56, the information exchange module 306 inquires of the determination module 404 of the determination module section 400 through the communication module 302 whether information exchange is required or not, for each program (Step #610 of FIG. 6). When an inquiry result that “the program requires information exchange” is obtained in Block B58 (Step #612 of FIG. 6), the information exchange module 306 reads, in Block B60, information (also referred to as “program information”) from the program area in the storage device 18 by the information management module 202 of the program, and stores the program information in the buffer area of the main memory 14. In addition, the information exchange module 306 reads information (also referred to as “saved information”) from the saving area in the storage device 18 by the information saving module 310 of the management module section 300, and stores the saved information in the buffer area of the main memory 14.

In Block B62, the information exchange module 306 stores the saved information of the buffer area of the main memory 14 in the program area in the storage device 18, and stores the program information of the buffer area of the main memory 14 in the saving area of the storage device 18. Thereby, the information of the program area is exchanged for the information of the saving area in the storage device 18 (Step #614 of FIG. 6).

When an inquiry result that “the program does not require information exchange” is obtained in Block B58 (Step #618 of FIG. 6), the information exchange processing in Blocks B60 and B62 is skipped, and the flow goes to Block B64 (Step #620 of FIG. 6).

The flow goes to Block B64, also when the information exchange apparatus has finished the information exchange processing of Blocks B60 and B62. In Block B64, it is determined whether the processing for all the programs has been finished or not. When it has not, the information processing apparatus returns to Block B56, and it is determined whether it is necessary to exchange information items for the next program.

Thereby, when the information processing apparatus 100 is switched from the first use to the second use, it is possible to save the information (information of the program area in the storage device 18) of the program which was executed for the first use in the saving area of the storage device 18, and write the information of the program, which was executed for the second use before the first use and saved in the saving area of the storage device 18, again in the program area of the storage device 18. Thereafter, although the information processing apparatus 100 performs processing for the second use, the information of the program which was executed for the first use is saved in the saving area of the storage device 18. Therefore, the program which is executed for the second use cannot read or write the information of the first use. The same is applicable to the case where the information processing apparatus 100 is switched from the second use to the first use again.

In the sequence diagram of switching the information processing apparatus from private use to business use illustrated in FIG. 7, the information exchange module 306 of the management module section 300 does not transmit any inquiry to the determination module section 400, and exchange information for all the programs. This is because the business information is saved in the saving area of the storage device 18, and it is determined that the information should always be changed to the information of business use when the information processing apparatus is switched to business use. On the other hand, when the information processing apparatus 100 is switched from business use to private use as illustrated in FIG. 6, the information for business use may include information which is not confidential, and thus the information switching module 306 makes an inquiry for each program. When the information processing apparatus 100 is switched from business use to private use, if the information of the program 200-1 which was processed for business use includes confidential information, the information of the program 200-1 is saved in the saving area of the storage device 18 from the program area of the storage device 18, and cannot be accessed from the program 200-1 which has been switched to private use. On the contrary, if the information of the program 200-2 which was processed for business use does not include confidential information, the information of the program 200-2 is not saved in the saving area of the storage device 18, and can be accessed even from the program 200-2 which has been switched to private use. These forms are also defined by the rules, and downloaded from the rule server 600 to the determination module 404.

As explained above, according to the embodiment, when the information processing apparatus 100 is switched from business use to private use, the confidential information for business use is saved, and cannot be accessed from the program. On the contrary, when the information processing apparatus 100 is switched from private use to business use, the information for private use is saved, and the saved confidential information for business use is restored. As described above, since accessible information is changed according to the use, security for the information processing apparatus is maintained regardless of change of use.

Since it is determined for each program based on the rules whether information exchange is performed or not, all the settings which were used in a business mode cannot always be used in a private mode. The private settings (such as wallpaper and key arrangement), which are allowed to be used by the company, can be maintained even when the information processing apparatus is used in a business mode.

Since information exchange is performed only inside the information processing apparatus 100, information exchange can be performed even when the company does not allow the user to transmit information to an external server in business use.

The determination processing of the determination module section 400 varies according to the policy of the company which uses the information processing apparatus. Therefore, when the management module section 300 is separated from the determination module section 400 such that the determination module section 400 can be replaced, the rules for determination can easily be updated without using the rule server 600. In addition, since the determination module section 400 has the function of connecting with the rule server 600, the determination module section 400 can perform determination flexibly and easily, based on the newest standard. On the other hand, the management module section 300 has a special right to access information of all the programs. Therefore, from the point of view of security, it is desired that the management module section 300 does not have any function of connecting to the Internet, but have a minimal function. Therefore, in the case of adopting a structure of separating the management module section 300 from the determination module section 400, it is possible to maintain both flexible determination and security.

Exchanging information of business use for information of private use by the information exchange module 306 is not uniformly performed, but an inquiry is transmitted to the determination module 404 of the determination module section 400. Thereafter, the information of the program 200-1, which is to be exchanged, is saved, and the information of the program 200-2, which does not require exchange, is not saved. Thereby, it is possible to reduce the time required for saving processing, and reduce the switching time. Since the determination module section 400 performs determination based on the rules received from the rule server 600 that is connected to the determination module section 400 through the Internet 500, the determination module section 400 can perform correct determination also for programs which were unknown when the information processing apparatus 100 was developed.

In addition, the accessible data items are exchanged in accordance with switching of uses as illustrated in the sequence of FIG. 7, and thereby it is possible to prevent unreliable data from entering the office, for example, the office network.

The uses to be switched are not limited to two, but three or more uses may be switched. In the case of adopting three or more uses, although the program areas of the storage device 18 may have the same structure, a plurality of saving areas should be provided for respective uses. When the information processing apparatus is operated for the first use, the saving areas save the program information of the second use and the program information of the third use. When the information processing apparatus is switched from the first use to the second (or third) use, the program information of the first use in the program area is exchanged for the program information of the second use (or third use) in the saving area.

According to the embodiment, the use switching module 406 of the determination module section 400 determines whether the use switching conditions are satisfied or not. When the use switching conditions are satisfied, the use switching module 406 transmits a use switching instruction to the management module section 300, and the use switching module 308 of the management module section 300 is configured to actually control the information exchange module 306 in response to the use switching instruction from the determination module section 400. The use switching module 308 of the management module section 300 may be omitted, and the use switching module 406 of the determination module section 400 may be configured to directly control the information exchange module 306 of the management module section 300.

In addition, the use switching event is not limited to connection of the information processing apparatus 100 to the office LAN, but the information processing apparatus 100 may have a near-field communication function, and may be switched when the user holds the information processing apparatus 100 over the reader, instead of the ID card, at the gate of the office entrance.

All the processes of the processing according to the present embodiment can be achieved by software, and thus the same effect as that of the present embodiment can easily be obtained, by installing a computer program which executes the processes in an ordinary computer through a computer-readable storage medium that stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising mode switching function, comprising:
a first management controller configured to access a first area of a memory; and
a second management controller configured to access the first area and another area of the memory, wherein
the first management controller is not configured to access the other area of the memory, and
the second management controller comprises an information exchange controller configured to exchange information in the first area of the memory for information in the other area of the memory, in accordance with mode switching.

2. The information processing apparatus of claim 1, wherein
the first management controller comprises information of a program configured to be executed by the information processing apparatus in the first area of the memory, and
the information exchange controller is configured to read the information of the program, which was processed before mode switching, from the first area of the memory, to read the information from the other area of the memory, to store the information of the program which was processed before mode switching in the other area of the memory, and to store the information which has been read from the other area of the memory in the first area of the memory.

3. The information processing apparatus of claim 2, wherein the information exchange controller comprises a buffer memory configured to temporarily store the information which has been read from the first area and the other area of the memory.

4. The information processing apparatus of claim 1, further comprising:
an instruction input controller configured to input a first mode switching instruction based on a user operation, and a second mode switching instruction based on detection of a first event of the information processing apparatus.

5. The information processing apparatus of claim 4, wherein the instruction input controller is configured to input the second mode switching instruction when the information processing apparatus is connected to a network.

6. The information processing apparatus of claim 5, wherein the instruction input controller comprises a memory comprising information of the first event.

7. The information processing apparatus of claim 4, wherein the instruction input controller is configured to determine whether the information processing apparatus is in a mode switching allowable state, when the user operation is detected, and to input the first mode switching instruction when the information processing apparatus is in the mode switching allowable state.

8. The information processing apparatus of claim 1, further comprising:
a determination controller configured to operate or not to operate the information exchange controller, in accordance with a program configured to be executed by the information processing apparatus.

9. The information processing apparatus of claim 8, wherein the determination controller comprises a memory comprising information, for each program, as to whether it is necessary to operate the information exchange controller.

10. The information processing apparatus of claim 9, wherein the memory comprises the information for each program as to whether it is necessary to operate the information exchange controller, the information received from a network.

11. An information processing method for an information processing apparatus comprising mode switching function, the apparatus comprising a first management controller configured to access a first area of a memory, and a second management controller configured to access the first area and another area of the memory, the method comprising:
exchanging information in the first area of the memory for information in the other area of the memory, in accordance with mode switching.

12. A non-transitory computer-readable storage medium comprising a computer program configured to be executed by a computer with mode switching function, the computer comprising a first management controller configured to access a first area of a memory, and a second management controller configured to access the first area and another area of the memory, the computer program comprising instructions configured to cause the computer to execute function of:
exchanging information in the first area of the memory for information in the other area of the memory, in accordance with mode switching.
